(19) United States
(12) Patent Application Publication
(10) Pub. No.: US 2011/0096076 A1
(43) Pub. Date: Apr. 28, 2011

(54) APPLICATION PROGRAM INTERFACE FOR ANIMATION

(75) Inventors: Paul Kwiatkowski, Redmond, WA (US); Sankhyayan Debnath, Seattle, WA (US); Martyn Lovell, Seattle, WA (US); Nicolas Brun, Seattle, WA (US); Robert Jarrett, Snohomish, WA (US); Billie Sue Chafins, Seattle, WA (US); Paul Gildea, Seattle, WA (US); Shawn Van Ness, Renton, WA (US); Jay Turney, Seattle, WA (US)

(73) Assignee: Microsoft Corporation, Redmond, WA (US)

(21) Appl. No.: 12/606,508

(22) Filed: Oct. 27, 2009

(51) Int. Cl. G06T 13/00

(52) U.S. Cl. 345/473

(57) ABSTRACT

Many computer applications incorporate and support animation. Application performance may be enhanced by delegating animation management to an application program interface (animation API) for animation. Accordingly, an animation API for managing animation is disclosed herein. The animation API may be configured to sequentially interpolate values of animation variables defining animation movement of animation objects. The animation API may interpolate the values of the animation variables using animation transitions within animation storyboards. The animation API may be configured to determine durations of animation transitions based upon animation characteristics parameters (e.g., starting position, desiring ending position, starting velocity of an animation variable). Durations and start times of animation transitions may be determined based upon key frames. The animation API may be configured to resolve scheduling conflicts among one or more animation transitions. Also, the animation API may be configured to facilitate smooth animation while switching between animation transitions for an animation variable.

### BACKGROUND

Today's user interfaces and computer applications incorporate animation to provide a robust user experience. Many of these applications maintain responsibility for changing values of their variables (e.g., an animation variable corresponding to a current rendering location of an animation object). Individually managing variables within an interactive computing system can become difficult for an application (e.g., an application within an interactive computing system may be configured to handle animation in response to user input, such as exposing a drop-down menu when a user selects a menu bar item). For example, the application may be responsible for resolving conflicts between instructions attempting to assign values to a single animation variable; ensuring appropriate values are assigned to animation variables (e.g., ensure smooth rendering of animation objects based upon appropriate changes to values of an animation variable over time); etc. Unfortunately, such responsibilities can become burdensome upon the application to the point of reducing a user's experience because of poor animation rendering.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, an animation application program interface (animation API) for managing animation is disclosed herein. It may be appreciated that an application may instantiate one or more animation variables associated with animation objects of the application. An animation variable may represent a value (e.g., a coordinate value) of an animation object associated with the application. The application may read the animation variable to determine a position at which to draw the animation object (e.g., the application may set up a loop to read the animation variable when an animation timer ticks). The animation API may be configured to update values of animation variables based upon storyboards defining animation as one or more animation transitions. An animation transition may be utilized by the animation API to sequentially interpolate values of the animation variable (e.g., the animation transition may be a set of mathematical functions describing how an animation object will move over time).

The animation API may comprise an animation scheduling component configured to determine a duration of a first animation transition based upon an animation character parameter of an animation variable. That is, the animation characteristic parameter (e.g., a starting value of the animation variable, a desired ending value of the animation variable, a starting velocity of the animation variable, period of oscillation, acceleration, etc.) may be used to determine a duration of an animation transition. It may be appreciated that one or more animation characteristic parameters may be used. It may be appreciated that the animation scheduling component, for example, may be configured to sequentially interpolate values of an animation variable using multiple animation transitions over time (e.g., a first animation transition and then a second animation transition).

The animation API may comprise a velocity matching component configured to determine a continuity parameter of the animation variable based upon at least one velocity measurement of the animation variable during sequential interpolation of values of the animation variable using the first animation transition. That is, the velocity matching component may determine a velocity measurement of an animation variable as interpolated by the animation scheduling component using the first animation transition. The velocity measurement may be utilized by the velocity matching component to determine a continuity parameter, from which the animation scheduling component may use in sequentially interpolating values of the animation variable using a second animation transition, thus providing a smooth switch between the first and second animation transition based upon matching velocity of the animation variable.

The animation API may comprise a contention management component configured to resolve scheduling conflicts between storyboards, where a collision is detected on a variable between a first animation transition of a first animation storyboard and a second animation transition of a second animation storyboard. That is, the contention management component may determine an execution priority of the first animation transition compared to the second animation transition. It may be appreciated that the execution priority may be determined with respect to the first animation storyboard and the second animation storyboard. The contention management component may be configured to detect collisions of a variable between the first and second animation storyboards. The animation scheduling component may sequentially interpolate values of the animation variable in accordance with the execution priority. For example, the first animation transition may be trimmed, so that the second animation transition may begin at a designated point of time. It may be appreciated that other examples of resolving scheduling conflicts are discussed herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of managing animation.

FIG. 2 is a component block diagram illustrating an exemplary system for managing animation through an animation application program interface.

FIG. 3 is an illustration of an example of an animation application program interface managing animation by scheduling one or more storyboards.

FIG. 4 is an illustration of an example of an animation application program interface managing animation by scheduling one or more transitions of a storyboard.

FIG. 5 is an illustration of an example of an animation application program interface managing animation using context sensitive durations.

FIG. 6 is an illustration of an exemplary computer-readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Managing the state of animated objects in a user interface can be challenging and resource intensive for an application. The application may track what objects are being animated and intermediate values of variables at any given moment of time. To complicate matters, while an object is being animated, user interaction may cause another animation to begin, which may cause conflicts between the animations, thus conflict resolution may be useful. Application performance may be enhanced by delegating animation management to an animation application program interface (animation API) for animation. That is, the application may be responsible for drawing objects, but the animation API may be responsible for determining values of animation variables corresponding to positions (e.g., coordinate values) at which the application may draw animation objects.

Accordingly, one or more techniques and/or systems for implementing an animation application program interface (API) for animation is provided herein. The animation API may be configured to perform tasks related to animation of objects. In one example, the animation API may be configured to support context sensitive animation along with key frame support. That is, the animation API may determine a duration of an animation transition based upon animation characteristic parameters (e.g., a starting value/position of an animation variable, a desired ending value/position of the animation variable, a starting velocity of the animation variable, etc.). It may be appreciated that a duration of an animation transition may be interpreted as a length of time in which an animation variable (e.g., a value corresponding to a position of an animation object) may be sequentially interpolated using the animation transition. This produces a series of values for the animation variable from which an application may read as position at which the application is to render the animation object.

In another example, the animation API may be configured to support velocity matching. That is, the animation API may be configured to determine a continuity parameter of an animation variable using a first animation transition, which may be utilized in interpolating values of the animation variable using a (subsequent) second animation transition. This may provide a smooth transition between animating an animation object using the first animation transition and then animating the animation object using the (subsequent) second animation transition. It may be appreciated that an animation transition may be, for example, a set of interpolators (e.g., mathematical functions) used to calculate values of an animation variable over time (e.g., a cosine function, a parabolic acceleration, linear, etc.), which may be used to determine how an animation object moves over time.

In yet another example, the animation API may be configured to support contention management. That is, the animation API may determine an execution priority with respect to a first animation transition and a second animation transition (e.g., in response to user input, a second animation transition may be scheduled for an animation variable during at least one point in time that a first animation transition is already scheduled for the animation variable, thus creating a conflict). It may be appreciated that conflicts may be detected between storyboards (e.g., new and/or already scheduled) on one or more animation variables. For example, the first animation transition may be trimmed, cancelled, completed early based upon an increased clock input, finished normally (the second animation transition waits or is cancelled), etc. to accommodate the second animation transition. It may be appreciated that it may be advantageous to have values of an animation variable interpolated using a single animation transition, as opposed to two animation transitions attempting to write values to the animation variable at similar (e.g., concurrent) times.

It may be appreciated that the animation API is not limited to the above examples. That is, the animation API may be configured to perform other techniques related to animation.

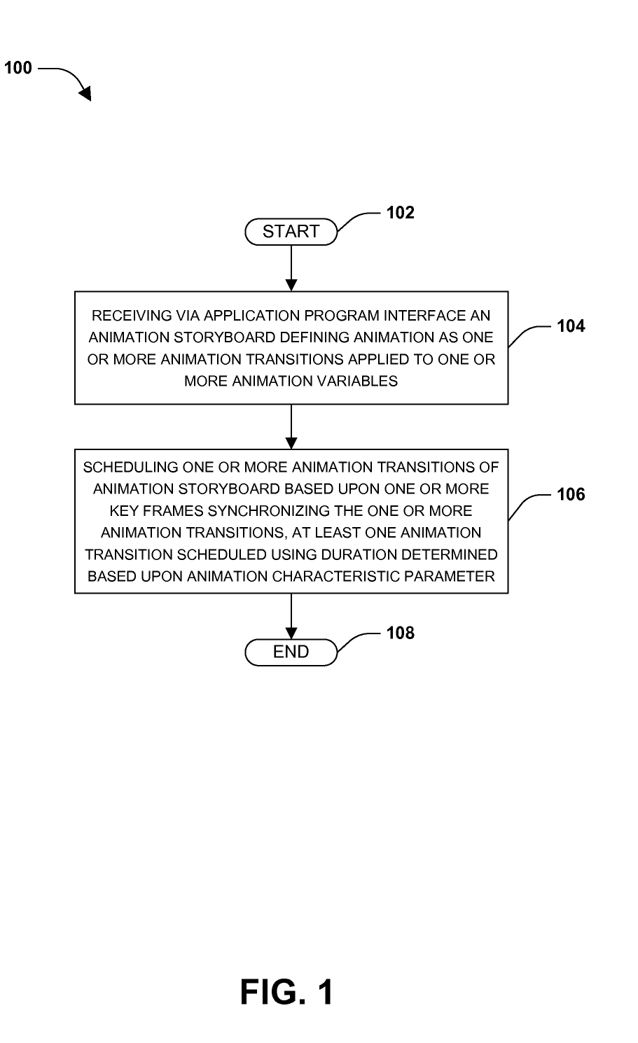

One embodiment of managing animation is illustrated by an exemplary method 100 in FIG. 1. At 102, the method begins. At 104, an animation storyboard defining animation as one or more animation transitions applied to one or more animation variables is received via an application program interface. The application program interface may be utilized in managing values for the one or more animation variables (e.g., values corresponding to one or more animation objects animated by an application within a user interface). For example, the application program interface may write values to the one or more animation variables which may be read by the application as coordinate values corresponding to positions at which one or more animation objects are to be rendered by the application. It may be appreciated that animation variables may represent color, transparency, rotation, size, etc. The application program interface may determine values for the animation variables using the one or more animation transitions defined by the animation storyboard. It may be appreciated that multiple storyboards may be utilized in managing animation variables of an application. The one or more animation transitions may comprise a set of interpolators (e.g., mathematical functions) which may be utilized in interpolating values of the one or more animation variables. The application may read the interpolated values of the animation variables when rendering the animation objects.

At 106, the one or more animation transitions of the animation storyboard may be scheduled based upon one or more key frames synchronizing the one or more animation transitions. At least one animation transition may be scheduled using a duration determined based upon an animation characteristic parameter. That is, the one or more key frames may be used to designate start and/or end times of animation transitions. Furthermore, a duration of at least one animation transition may be determined, such that the duration defines a period of time in which the animation transition is used for interpolating values of an animation variable. For example, the duration may be based upon a starting value, a desired ending value, and/or a starting velocity of an animation variable, thus making the duration of the at least one animation transition context sensitive based upon other transitions, the current state of the animation variable, and/or the desired state of the animation variable.

As an illustrative example, a car image (e.g., an animation object) may be designated by a first animation transition to move (to the right) from a left most position (e.g., a starting position) to a right most position (e.g., a desired ending position). If for example, the car image has moved halfway between the starting position and the desired ending position and user input occurs specifying a second animation transition defining a new desired ending position as the left most position, then a duration of the second animation transition may be shorter (e.g., shorter than if the car image was at the right most position as the new starting position), due to the new starting position of the car image as half the distance as if the new starting position was based upon the desired ending position of the first animation transition. That is, the car image has only half the distance to travel to reach the new desired ending position, as specified by the second animation transition, in comparison to if the car image had completed its journey to the left most position. It may be appreciated that in this example, the first animation transition is trimmed while the car image is halfway to the desired ending position of the first animation transition and that the second animation transition is started when the car image is still halfway (e.g., the car image is closer to the new desired destination value).

It may be appreciated that values of the one or more animation variables may be sequentially interpolated using a user customized interpolator. That is, a user may create a user customized interpolator comprising mathematical functions used to produce interpolated values of animation variables describing how animations objects are to move. It may be appreciated that the values of the one or more animation variables may be sequentially interpolated based upon a user specified type (e.g., integer values, double precision floating point values, etc.).

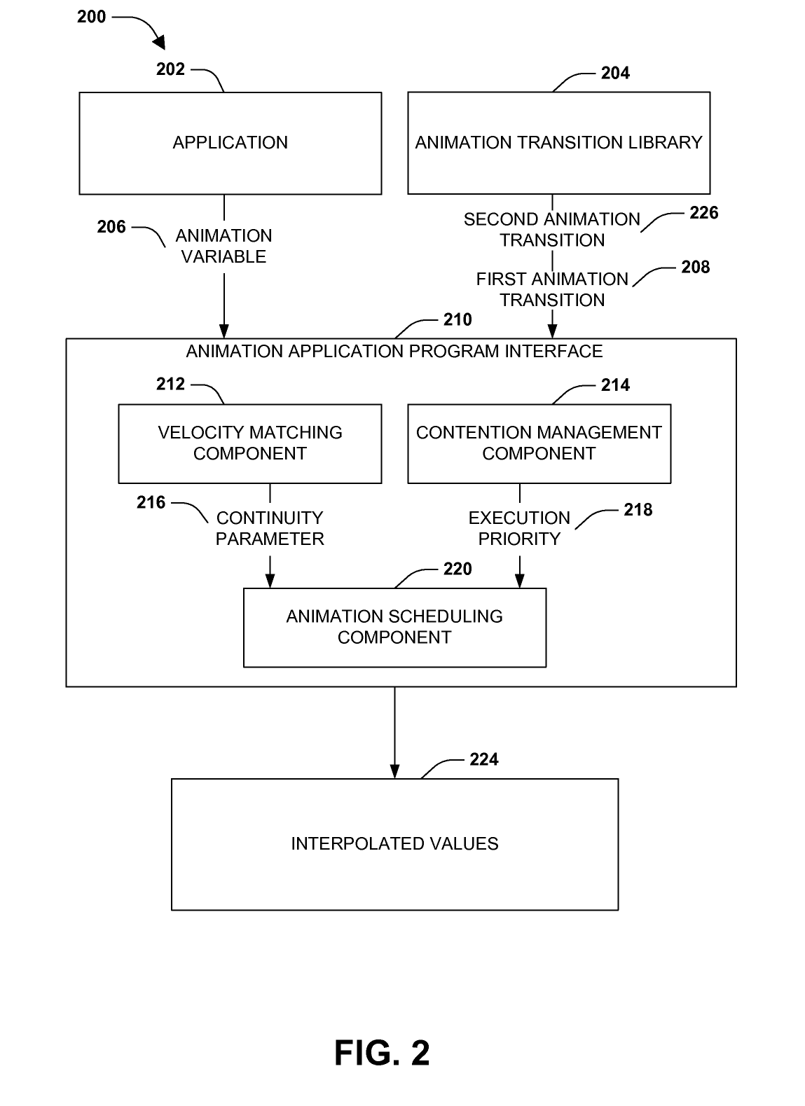

FIG. 2 illustrates an example of a system 200 configured to manage animation through an animation application program interface (an animation API 210). The animation API 210 may comprise an animation scheduling component 220, a velocity matching component 212, and/or a contention management component 214. It may be appreciated that the animation API 210 may be configured to interface with an application 202 to facilitate animation. That is, the animation API 210 may be configured to sequentially interpolate values of animation variables using animation transitions. The interpolated values 224 may be read by the application 202 as coordinate values at which to draw corresponding animation objects over time. It may be appreciated that animation transitions (e.g., a first animation transition 208, a second animation transition 226, etc.) may be retrieved from a transition library 204.

The animation scheduling component 220 may be configured to determine a duration of the first animation transition 208 based upon an animation characteristic parameter of an animation variable 206 (e.g., an animation variable having at least one value calculated using the first animation transition). That is, the duration of the first animation transition 208 may not be specified, however, the duration may be context sensitive based upon animation characteristic parameters (e.g., a starting value, a desired ending value, and a starting velocity of the animation variable). In one example, the first animation transition 208 may define how to calculate values of the animation variable 206 defining how an animation object is to move (e.g., one full circle motion) as animation by the application 202. If for example, a previous animation transition was applied to the animation variable 206 causing the animation object to move with at a high velocity, then that velocity may be used as the starting velocity when applying the first animation transition 208. This high starting velocity may be taken into account when determining the duration of the first animation transition 208 (e.g., the duration of the first animation transition 208 may be shortened because the animation object may reach a desired ending position faster due to the high starting velocity).

The animation scheduling component 220 may be configured to interpolate values of the animation variable 206 using the first animation transition 208 and its duration (e.g., interpolated values 224 using the first animation transition 208 over its duration). The interpolated values 224 may be read by the application 202 as coordinate values/positions at which to draw the animation object corresponding to the animation variable 206. The animation scheduling component 220 may be configured to interpolate values of the animation variable 206 using the second animation transition 226 and a second duration, the second duration determined based upon an animation characteristic parameter of the animation variable 206. It may be appreciated that the second duration may be based upon multiple animation characteristic parameters. It may be appreciated that multiple animation transitions may be applied to animation variables over time to generate one or more animations of an animation object. It may be appreciated that the animation API 210 may be configured to sequentially interpolate multiple animation variables using multiple animation transitions and/or animation storyboards.

The velocity matching component 212 may be configured to determine a continuity parameter 216 based upon at least one velocity measurement of the animation variable 206 during sequential interpolation of values of the animation variable 206 using the first animation transition 208. The animation scheduling component 220 may be configured to sequentially interpolate values of the animation variable 206 using the second animation transition 226 in accordance with the continuity parameter 216. For example, a car object (e.g., an animation object) may be animated using the first animation transition 208 (e.g., the animation scheduling component 220 sequentially interpolates values of the animation variable 206 corresponding to the car object, which the application 202 reads as coordinates values at which to draw the car object). The second animation transition 226 may be scheduled and utilized after the first animation transition 208, such that the second animation transition 226 defines how the car object is to move next. To provide a smooth switch from animating the car object using the first animation transition 208 to using the second animation transition 226, a continuity parameter of the animation variable 206 as sequentially interpolated by the first animation transition 208 may be determined and used when switching to the second animation transition 226 (e.g., match the starting velocity of the animation variable 206 as sequentially interpolated by the second animation transition 226 to the velocity measurement of the animation variable 206 as sequentially interpolated by the first animation transition 208).

The contention management component 214 may be configured to resolve conflicts between the first animation transition 208 and the second animation transition 226. That is, the contention management component 214 may determine an execution priority 218 of the first animation transition 208 compared with the second animation transition 226. In a first example, the contention management component 214 may determine the execution priority 218 as specifying that the first animation transition 208 is to be trimmed to fit the second animation transition 226 into the schedule at a desired starting time. The animation scheduling component may be configured to sequentially interpolate the values of the animation variable 206 in accordance with the execution priority 218 by trimming the first animation transition 208 and initiating the second animation transition 226. In a second example, the contention management component 214 may determine the execution priority 218 as specifying that the first animation transition 208 is to be cancelled before the first animation transition 208 begins, and that the second animation transition 226 is to be initiated thereafter.

In a third example, the contention management component 214 may determine the execution priority 218 as specifying that a clock input is to be increased so that the first animation transition 208 is completed early (e.g., completed within a specified amount of time), and that the second animation transition 226 is to be initiated after the early completion. In a fourth example, the contention management component 214 may determine the execution priority 218 as specifying that the first animation transition 208 is to be completed as scheduled, and that the second animation transition 226 is to wait for completion of the first animation transition 208 before being initiated. In a fifth example, the contention management component 214 may determine the execution priority 218 based upon a longest acceptable delay defined for the second animation transition 226. In a sixth example, the second animation transition 226 may be cancelled because of the conflict. It may be appreciated that the animation scheduling component 220 may be configured to sequentially interpolate values of the animation variable 206 based upon the execution priority 218.

In a second example of the animation API 210, the animation scheduling component 220 may be configured to determine a duration of an animation transition of a storyboard based upon an animation characteristic parameter of an animation variable. The animation scheduling component may sequentially interpolate values of the animation variable using the animation transition and a continuity parameter for a time period equal to the duration. The velocity matching component may be configured to determine the continuity parameter of the animation variable based upon at least one velocity measurement of the animation variable during sequential interpolation of the values of the animation variable using a pervious animation transition preceding the animation transition. The contention management component may be configured to resolve a scheduling conflict between one or more animation transitions.

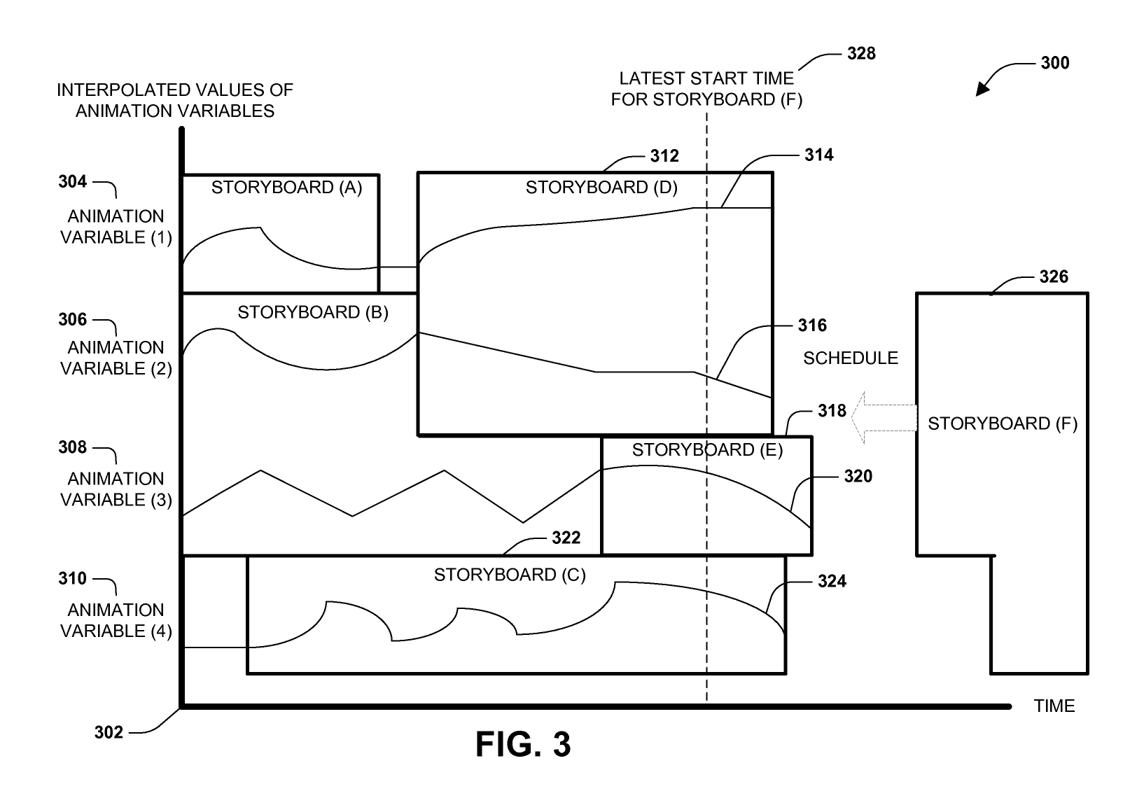

FIG. 3 illustrates an example 300 of an animation application program interface (animation API) managing animation by scheduling one or more storyboards. An animation schedule graph 302 may comprise a time axis and an interpolated values of animation variables axis. The animation API may be configured to schedule one or more storyboards (e.g., a storyboard (A), a storyboard (B), a storyboard (C) 322, a storyboard (D) 312, a storyboard (E) 318, a storyboard (F) 326, etc.) that are to be applied to one or more animation variables (e.g., animation variable (1) 304, animation variable (2) 306, animation variable (3) 308, animation variable (4) 310, etc.). For example, storyboard (A) may comprise one or more animation transitions which may be applied to the animation variable (1) 304 over time. The values of the animation variable (1) 304 may be read by an application as coordinate values at which the application may draw an animation object corresponding to the animation variable (1) 304. It may be appreciated that animation transitions within one or more of the storyboards may have undefined durations, such that the animation API may determine durations based upon animation characteristic parameters.

In one example, the animation API may have scheduled storyboards (A-E) for corresponding animation variables (1-4). An animation scheduling component may be configured to sequentially interpolate values of the animation variables based upon animation transitions (e.g., animation transition 324 of storyboard (C) 322, animation transition 314 and animation transition 316 of storyboard (D) 312, and animation transition 320 of storyboard (E) 318) within the storyboards.

The animation API may receive storyboard (F) 326 to schedule within the animation schedule graph 302. A scheduling conflict may occur because storyboard (D) 312, storyboard (E) 318, and storyboard (C) 322 are scheduled to operate upon animation variables (e.g., animation variable (2) 306, animation variable (3) 308, and animation variable (4) 310) that storyboard (F) 326 is scheduled to operate upon at a concurrent time. That is, a latest start time for storyboard (F) 328 is designated during a time period at which storyboards (C), (D), and (E) are to be used in interpolating values for animation variables (2-4), a time period at which storyboard (F) 328 is also to be used in interpolating the values for the animation variables (2-4). It may be appreciated that it may be useful to utilize a single animation transition and/or storyboard when interpolating an animation variable as opposed to using multiple animation transitions at once. This creates a conflict because values of an animation variable are to be interpolated by a single animation transition within a storyboard at any given moment in time. A contention management component may be configured to resolve the scheduling conflict between storyboard (F) 326 and storyboards (C), (D), and (E). In one example, a clock input to storyboard (D) 312 may be increased to finish storyboard (D) 312 before the latest start time for storyboard (F) 328. It may be appreciated that in one example, clock inputs to storyboards A-D may be increased to maintain timeliness, whereas unrelated animation variables 5 and 6 may not be sped up. In another example, storyboard (E) 318 may be cancelled before it starts. In yet another example, storyboard (C) 322 may be trimmed.

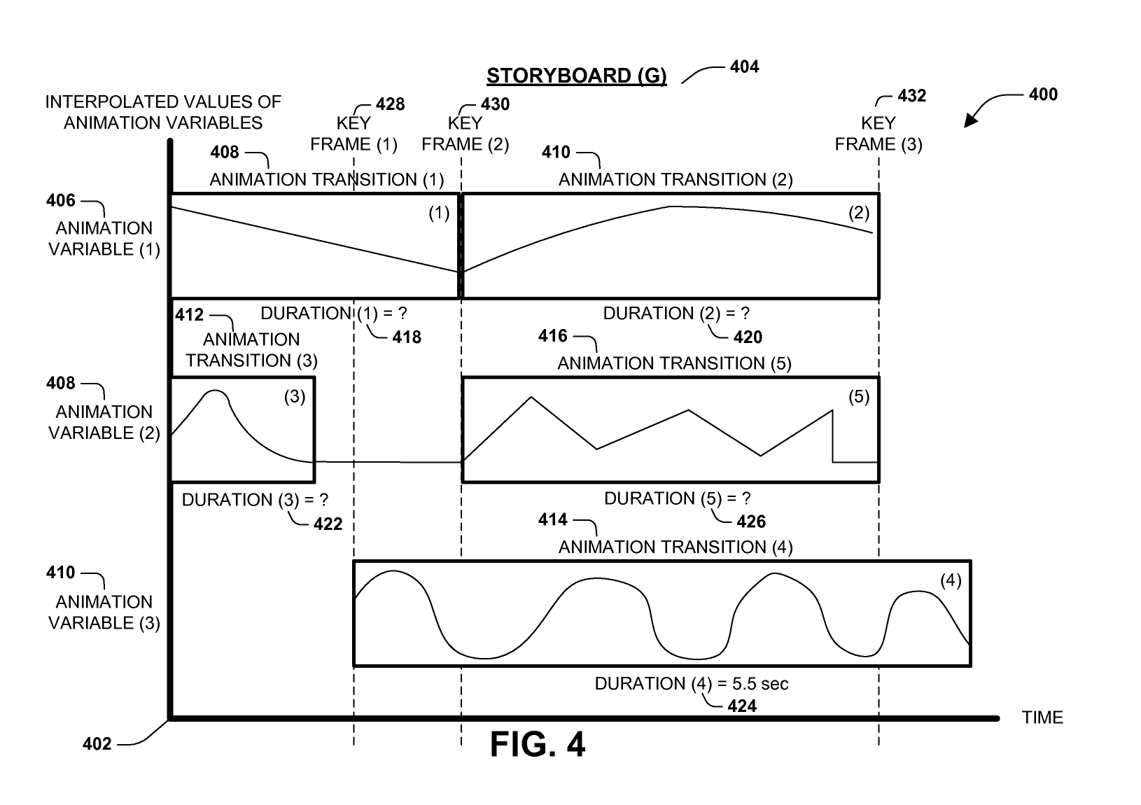

FIG. 4 illustrates an example 400 of an animation application program interface (animation API) managing animation by scheduling one or more transitions of a storyboard. An animation schedule graph 402 of storyboard (G) 404 may comprise a time axis and interpolated values of animation variables axis. The animation API may be configured to schedule one or more animation transitions (e.g., animation transition (1) 408, animation transition (2) 410, animation transition (3) 412, animation transition (4) 414, and/or animation transition (5) 416), which may be used to sequentially interpolate values of one or more animation variables (e.g., animation variable (1) 406, animation variable (2) 408, animation variable (3) 410).

Animation transition (4) 414 comprises a specified duration (4) 424 of 5.5 seconds. That is, values for the animation variable (3) 410 may be sequentially interpolated using the animation transition (4) 414 over a time period of 5.5 seconds. It may be appreciated that at least one of the animation transitions may not have a specified duration parameter (e.g., animation transition (1) 408 having an unspecified duration (1) 418, animation transition (2) 410 having an unspecified duration (2) 420, animation transition (3) 412 having an unspecified duration (3) 422, and animation transition (5) 416 having an unspecified duration (5) 426). The animation API may be configured to determine durations for the animation variables having unspecified durations based upon animation characteristic parameters of respective animation variables and/or based upon key frames (e.g., key frame (1) 428, key frame (2) 430, and/or key frame (3) 432) of respective animation transitions. It may be appreciated that a key frame may be used to designate starting times and/or an ending times of animation transitions. Furthermore, among other things, a key frame time may be determined by an end time of an animation transition. For example, a time of key frame (1) 428 is at a fixed offset from the start of the storyboard, while a time of key frame (2) 430 depends upon the end of animation transition (1) 408. Also, start times and/or end times of animation transitions may be determined based upon key frame times.

In one example, the animation API may schedule animation transition (4) 414 to start at key frame (1) 428 (with the duration (4) 424 at 5.5 sec), along with scheduling animation transition (2) 410 and animation transition (5) 416 to start at key frame (2) 430 and end at key frame (3) 432. The animation API may determine a value for the unspecified duration (2) 420 for animation transition (2) 410 based upon the starting value of animation variable (1) 406 as interpolated by animation transition (1) 408 and based upon a desired ending position of the animation variable (1) 406 after interpolation by animation transition (2) 410. The animation API may determine a value for the unspecified duration (5) 426 for animation transition (5) 416 based upon the starting value of animation variable (2) as interpolated by animation transition (3) 412 and based upon a desired ending position of the animation variable (2) after interpolation by animation transition (5) 416. In this way, animation transitions may be schedule with durations specified by the animation API using animation characteristic parameters.

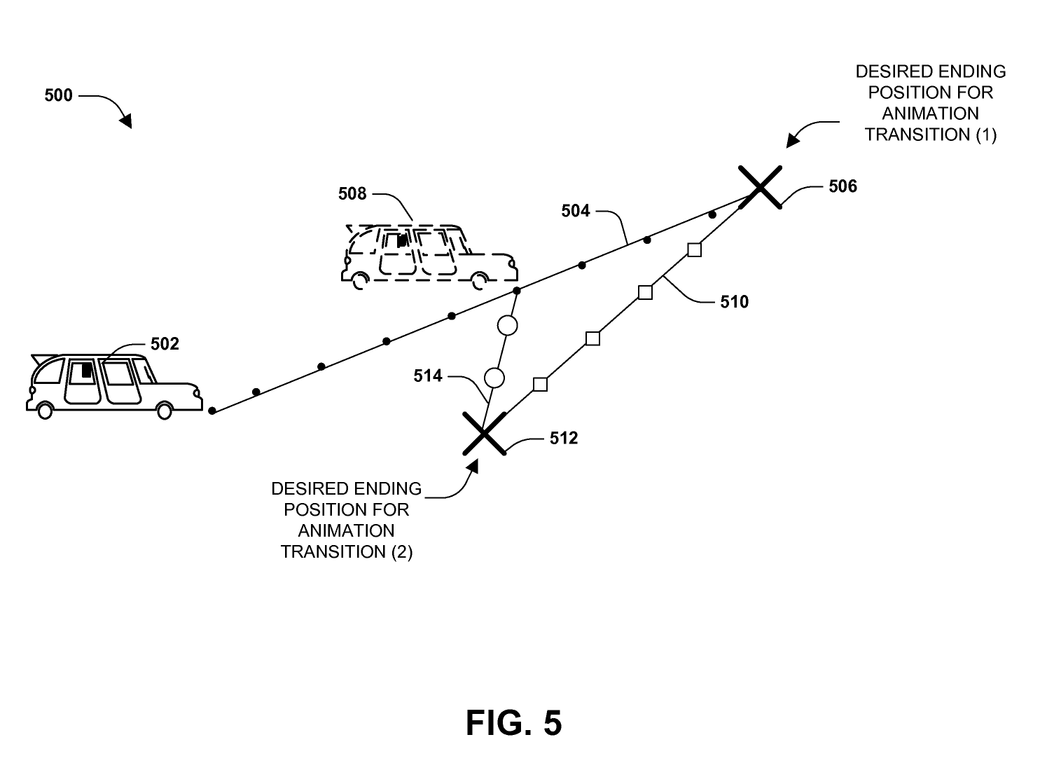

FIG. 5 illustrates an example 500 of an animation application program interface (animation API) managing animation using context sensitive durations. A car image 502 may be an animation object associated with an application. The application may render the car image 502 at coordinate positions specified by an animation variable over time. In one example, an animation transition (1) may be used in sequentially interpolating values for the animation variable. The application may render the car image 502 along an animation path (1) 504 based upon the values of the animation variable as calculated using the animation transition (1). A desired ending position (1) 506 may designate when the animation variable for the car image 502 is done being interpolated by the animation transition (1). That is, once the car image 502 reaches the desired ending position (1) 506, then the animation transition (1) is done.

An animation transition (2) may be scheduled after the animation transition (1), such that after the animation transition (1) is done, then the animation transition (2) is used to sequentially interpolate values for the animation value associated with the car image 502. It may be appreciated that the animation transition (2) may be scheduled and/or utilized before animation transition (1) is done, for example due to user input. In one example, an instruction to interpolate values using the animation transition (2) as opposed to the animation transition (1) may be received when the car image 502 has reached position 508. The animation transition (2) may have an unspecified duration, but has a desired ending position (2) 512 and/or one or more other parameters (e.g., speed, acceleration, etc.). It may be appreciated that the animation transition (1) may be cancelled while the car image 502 is at position 508, thus the car image 502 does not reach the desired ending position 506. If the animation transition (1) had completed, then the animation transition (2) may have been utilized/scheduled for a longer duration because the animation path (2) 510 is longer than the distance between the current position of the car image 502, at position 508, and the desired ending position (2) 512. Thus an animation path (3) 514 may be generated from interpolating values of the animation variable of the car image 502 for a shorter duration because the car image 502, at position 508, is close to the desired ending position (2) 512. The duration of the animation transition (2) is adjusted based upon animation characteristic parameters—the desired ending position (2) 512 and a starting position of the car image 502, at position 508.

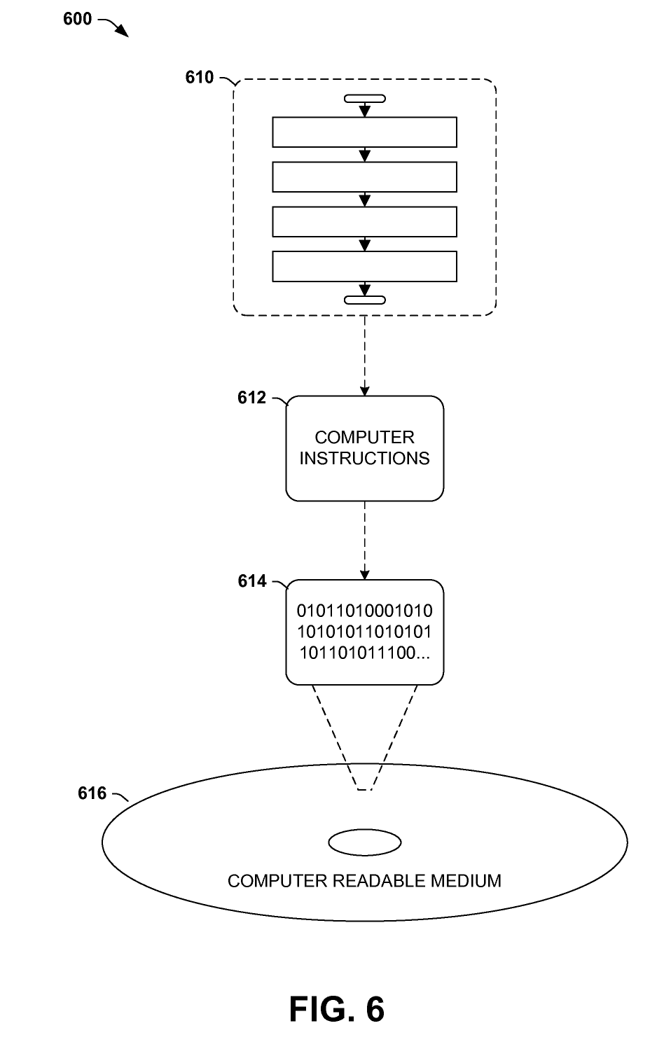

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 616 (e.g., a CD-R, DVD-R, or a platter of a hard disk drive), on which is encoded computer-readable data 614. This computer-readable data 614 in turn comprises a set of computer instructions 612 configured to operate according to one or more of the principles set forth herein. In one such embodiment 600, the processor-executable instructions 612 may be configured to perform a method 610, such as the exemplary method 100 of FIG. 1, for example. That is, the processor-executable instructions 612 may implement the exemplary method 100 as an application program interface (animation API) which may be executed via one or more processors. In another such embodiment, the processor-executable instructions 612 may be configured to implement a system, such as the exemplary system 200 of FIG. 2 (e.g., the animation application program interface), for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

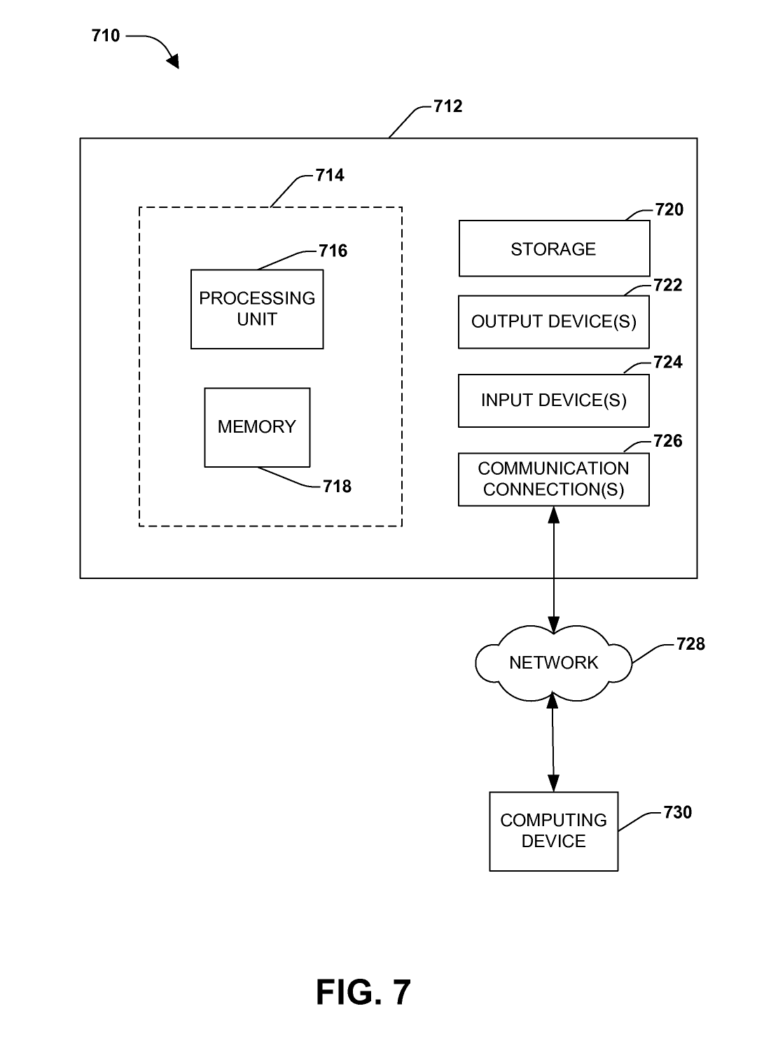

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.

What is claimed is:

1. An animation application program interface (API) for managing animation comprising:
an animation scheduling component configured to determine a duration of a first animation transition based upon an animation characteristic parameter of an animation variable.

2. The system of claim 1, the animation characteristic parameter comprising at least one of:
a starting value of the animation variable;
a desired ending value of the animation variable; and
a starting velocity of the animation variable.

3. The system of claim 1, the animation scheduling component configured to sequentially interpolate values of the animation variable using the first animation transition and the duration.

4. The system of claim 3, the animation scheduling component configured to sequentially interpolate values of the animation variable using a second animation transition and a second duration, the second duration determined based upon an animation characteristic parameter of the animation variable.

5. The system of claim 1, comprising:
a velocity matching component configured to determine a continuity parameter of the animation variable based upon at least one velocity measurement of the animation variable during sequential interpolation of values of the animation variable using the first animation transition.

6. The system of claim 5, the animation scheduling component configured to sequentially interpolate values of the animation variable using a second animation transition in accordance with the continuity parameter.

7. The system of claim 1, comprising:
a contention management component configured to resolve a scheduling conflict between the first animation transition and a second animation transition.

8. The system of claim 7, the contention management component configured to determine an execution priority of the first animation transition compared to the second animation transaction.

9. The system of claim 8, the animation scheduling component configured to sequentially interpolate values of the animation variable in accordance with the execution priority.

10. The system of claim 9, the animation scheduling component configured to sequentially interpolate values of the animation variable in accordance with the execution priority by trimming the first animation transition and initiating the second animation transition.

11. The system of claim 9, the animation scheduling component configured to sequentially interpolate values of the animation variable in accordance with the execution priority by cancelling the first animation transition before the first animation transition begins and initiating the second animation transition.

12. The system of claim 9, the animation scheduling component configured to sequentially interpolate values of the animation variable in accordance with the execution priority by increasing a clock input so that the first animation transition completes within a specified amount of time and initiating the second animation transition upon completion of the first animation transition.

13. The system of claim 9, the animation scheduling component configured to sequentially interpolate values of the animation variable in accordance with the execution priority by completing the first animation transition and initiating the second animation transition.

14. The system of claim 7, the contention management component configured to determine the execution priority based upon a longest acceptable delay defined for the second animation transition.

15. The system of claim 1, the animation scheduling component configured to sequentially interpolate values of the animation variable using a user customized interpolator.

16. A method for managing animation comprising:
receiving via an animation application program interface (API) an animation storyboard defining animation as one or more animation transitions applied to one or more animation variables; and
scheduling the one or more animation transitions of the animation storyboard based upon one or more key frames synchronizing the one or more animation transitions, at least one animation transition scheduled using a duration determined based upon an animation characteristic parameter.

17. The method of claim 16, comprising:
determining a start time of an animation transition based upon one or more key frames.

18. The method of claim 16, comprising:
determining an end time of an animation transition based upon one or more key frames.

19. The method of claim 16, comprising:
scheduling a key frame at a time based upon one or more animation transition end times.

20. An animation application program interface (API) for managing animation comprising:
an animation scheduling component configured to:
determine a duration of an animation transition of a storyboard based upon an animation characteristic parameter of an animation variable; and
for a time period equal to the duration, sequentially interpolate values of the animation variable using the animation transition and a continuity parameter; and
a velocity matching component configured to:
determine the continuity parameter of the animation variable based upon at least one velocity measurement of the animation variable during sequential interpolation of the values of the animation variable using a previous animation transition preceding the animation transition; and
a contention management component configured to:
resolve a scheduling conflict between one or more animation transitions.
